(19) United States
(12) Patent Application Publication
(10) Pub. No.: US 2020/0125281 A1
(43) Pub. Date: Apr. 23, 2020

(54) MEMORY SYSTEM AND METHOD OF OPERATING THE SAME

(71) Applicant: SK hynix Inc., Gyeonggi-do (KR)

(72) Inventors: Dong Ham YIM, Gyeonggi-do (KR); Young Guen CHOI, Gyeonggi-do (KR)

(21) Appl. No.: 16/408,042

(22) Filed: May 9, 2019

(30) Foreign Application Priority Data
Oct. 23, 2018 (KR) 10-2018-0127049

(51) Int. Cl. G06F 3/06

(52) U.S. Cl. CPC G06F 3/0631; G06F 3/0679; G06F 3/0604

(57) ABSTRACT

Provided herein may be a memory system and a method of operating the same. The memory system may include: a memory device including a plurality of memory blocks; and a controller configured to generate one or more streams in response to a request from a host, configure one or more super blocks respectively corresponding to the one or more streams, each of the one or more super blocks including free blocks, and control the memory device to perform a data write operation on the one or more super blocks. The controller may allocate, among the one or more super blocks, an additional free block to a super block that needs the additional free block when the data write operation has not yet been completed.

### CROSS-REFERENCE TO RELATED APPLICATION

The present application claims priority under 35 U.S.C. § 119(a) to Korean patent application number 10-2018-0127049, filed on Oct. 23, 2018, the entire disclosure of which is incorporated herein by reference in its entirety.

### BACKGROUND

### Field of Invention

Various embodiments of the present disclosure generally relate to an electronic device, and more particularly, to a memory system and a method of operating the memory system.

### Description of Related Art

Recently, the paradigm for the computer environment has shifted to ubiquitous computing, which enables computer systems to be used anytime and anywhere. Thereby, the use of portable electronic devices such as mobile phones, digital cameras, and notebook computers has rapidly increased. In general, such portable electronic devices use a memory system which employs a memory device, in other words, a data storage device. The data storage device is used as a main memory device or an auxiliary memory device of the portable electronic devices.

A data storage device used as a memory device provides advantages in that, since there is no mechanical driving part, stability and durability are excellent, information access speed is increased, and power consumption is reduced. Data storage devices having such advantages include a universal serial bus (USB) memory device, a memory card having various interfaces, a solid state drive (SSD), and the like.

Memory devices are classified into volatile memory devices and nonvolatile memory devices.

The nonvolatile memory device can retain data stored therein even when power supply is interrupted, although read and write speeds are comparatively low. Therefore, the nonvolatile memory device is used when there is the need for retaining stored data regardless of whether or not it is connected to a power supply. Representative examples of a nonvolatile memory device include a read-only memory (ROM), a mask ROM (MROM), a programmable ROM (PROM), an erasable programmable ROM (EPROM), an electrically erasable programmable ROM (EEPROM), a flash memory, a phase-change random access memory (PRAM), a magnetic RAM (MRAM), a resistive RAM (RRAM), and a ferroelectric RAM (FRAM). The flash memory is classified into a NOR type memory and a NAND type memory.

### SUMMARY

Various embodiments of the present disclosure are directed to a memory system and a method of operating the memory system, in which a multi-stream operation is possible and a super block including a minimum number of free blocks may be allocated to each stream.

An embodiment of the present disclosure may provide for a memory system including: a memory device including a plurality of memory blocks; and a controller configured to generate one or more streams in response to a request from a host, configure one or more super blocks respectively corresponding to the one or more streams, each of the one or more super blocks including free blocks, and control the memory device to perform a data write operation on the one or more super blocks. The controller may allocate, among the one or more super blocks, an additional free block to a super block that needs the additional free block when the data write operation has not yet been completed.

An embodiment of the present disclosure may provide for a memory system including: a memory device including a plurality of memory blocks; and a controller configured to allocate some of the plurality of memory blocks to a super block, the allocated memory blocks including programmable free blocks, and control the memory device to perform a data write operation on the super block. When all programmable free blocks of the allocated memory blocks are consumed when the data write operation on the super block has not been completed, the controller may add an additional free block, among the plurality of memory blocks excluding the allocated memory blocks to the super block.

An embodiment of the present disclosure may provide for a method of operating a memory system, including: generating a stream in response to a write request from a host; configuring a super block including free blocks of a plurality of memory blocks included in a memory device; allocating the super block to the stream; performing a data write operation on the super block; and reconfiguring the super block by adding an additional free block to the super block when all of the free blocks included in the super block are consumed during the data write operation.

An embodiment of the present disclosure may provide for a memory system including: a memory device including a plurality of memory blocks; and a controller suitable for: generating a stream corresponding to write data received from a host; controlling the memory device to perform a data write operation on a first super block corresponding to the stream, the first super block including a set of blocks among the plurality of memory blocks, the set blocks including free blocks; determining whether an additional free block is needed during the data write operation of the stream; and when it is determined that the additional free block is needed, allocating at least one additional free block, which is in a second super block, to the first super block for the data write operation of the stream.

### BRIEF DESCRIPTION OF THE DRAWINGS

FIG. 1 is a block diagram illustrating a memory system in accordance with an embodiment of the present disclosure.

FIG. 2 is a block diagram illustrating a configuration of a controller, such as that of FIG. 1, in accordance with an embodiment of the present disclosure.

FIG. 3 is a diagram illustrating a semiconductor memory, such as that of FIG. 1, in accordance with an embodiment of the present disclosure.

FIG. 4 is a diagram illustrating a memory block, such as that of FIG. 3, in accordance with an embodiment of the present disclosure.

FIG. 5 is a diagram illustrating a memory block having a three-dimensional structure in accordance with an embodiment of the present disclosure.

FIG. 6 is a diagram illustrating a memory block having a three-dimensional structure in accordance with an embodiment of the present disclosure.

FIG. 7 is a diagram illustrating a configuration of a super block in accordance with an embodiment of the present disclosure.

FIG. 8 is a diagram illustrating a multi-stream operation between a controller and a memory device in accordance with an embodiment of the present disclosure.

FIG. 9 is a flowchart illustrating a method of operating a memory system in accordance with an embodiment of the present disclosure.

FIG. 10 is a diagram illustrating a memory system in accordance with an embodiment of the present disclosure.

FIG. 11 is a diagram illustrating a memory system in accordance with an embodiment of the present disclosure.

FIG. 12 is a diagram illustrating a memory system in accordance with an embodiment of the present disclosure.

FIG. 13 is a diagram illustrating a memory system in accordance with an embodiment of the present disclosure.

### DETAILED DESCRIPTION

Specific structural and functional description provided herein is directed to embodiments of the present disclosure. Such description, however, is not intended to limit the invention to the described embodiments. Moreover, throughout the specification, reference to “an embodiment,” “another embodiment” or the like is not necessarily to only one embodiment, and different references to any such phrase are not necessarily to the same embodiment(s).

As those skilled in the art will understand from the present disclosure, the present invention may be embodied in many different forms, including modifications of any of the disclosed embodiments. Thus, the present invention is not limited to only the embodiments set forth herein. Rather, the present invention should be construed as covering all modifications, equivalents and alternatives that fall within the spirit and scope of the present disclosure.

It will be understood that, although the terms “first”, “second”, etc. may be used herein to identify various elements, these elements should not be limited by these terms. These terms are only used to distinguish one element from another element that otherwise have the same or similar names. For instance, a first element may later be termed a second element, or vice versa, without departing from the teachings of the present disclosure.

It will be understood that when an element is referred to as being “coupled” or “connected” to another element, it can be directly coupled or connected to the other element or one or more intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to” or directly adjacent to” should be construed in the same way.

The terminology used herein is for the purpose of describing particular embodiments only and is not intended to be limiting. In the present disclosure, the singular forms are intended to include the plural forms as well, unless the context clearly indicates otherwise. The articles ‘a’ and ‘an’ as used in this application and the appended claims should generally be construed to mean ‘one or more’ unless specified otherwise or clear from context to be directed to a singular form. It will be further understood that the open-ended terms “comprise”, “include”, “have”, etc., when used in this specification, specify the presence of stated features, integers, steps, operations, elements, components, and/or combinations of them but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and not be interpreted in an idealized or overly formal sense unless expressly so defined herein.

Detailed description of functions and structures well known to those skilled in the art is omitted to avoid obscuring the subject matter of the present disclosure. This aims to omit unnecessary description so as to make the subject matter of the present disclosure clear.

Various embodiments of the present disclosure will now be described more fully with reference to the accompanying drawings, in which preferred embodiments of the present disclosure are shown, so that those skilled in the art can easily practice the present invention.

FIG. 1 is a block diagram illustrating a memory system 1000 in accordance with an embodiment of the present disclosure.

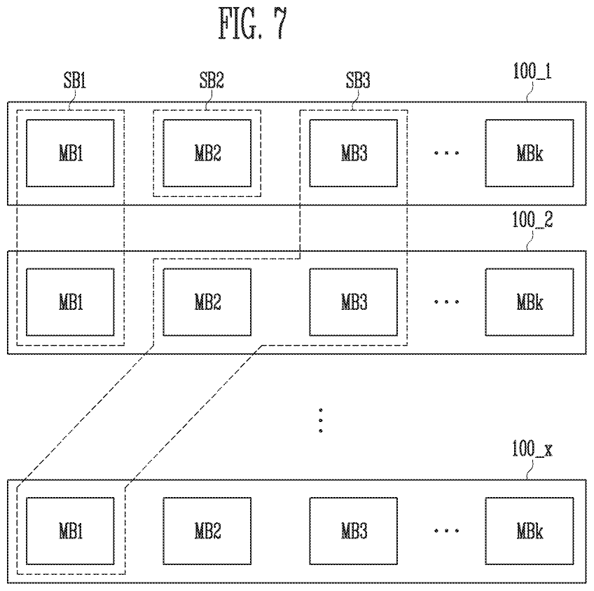

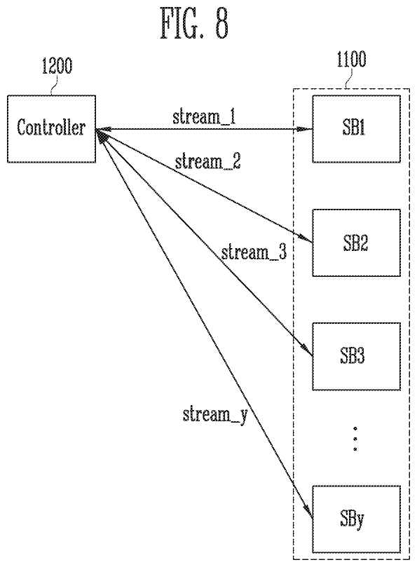

Referring to FIG. 1, the memory system 1000 may include a memory device 1100 and a controller 1200. The memory device 1100 may include a plurality of semiconductor memories 100. The plurality of semiconductor memories 100 may be divided into a plurality of groups. Furthermore, the memory system 1000 may divide a plurality of memory blocks included in the plurality of semiconductor memories 100 into a plurality of super blocks each including at least one memory block. The memory system 1000 may support multi-streams. Each of the multi-streams may be allocated with one super block and operated. The super blocks and a method of allocating the super blocks to the multi-streams will be described below with reference to FIGS. 7 and 8.

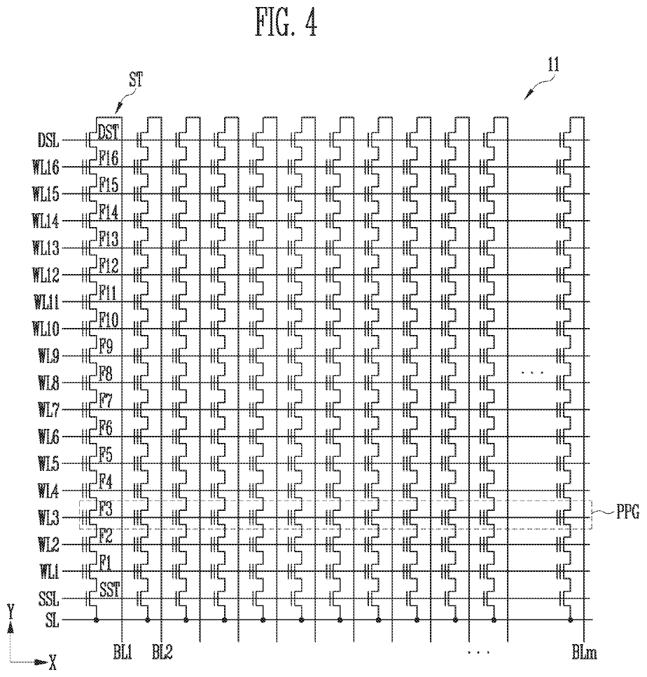

In FIG. 1, it is illustrated that the plurality of groups, i.e., first to n-th groups, of semiconductor memories, communicate with the controller 1200 through first to n-th channels CH1 to CHn, respectively. Each semiconductor memory 100 will be described in detail later with reference to FIG. 3.

Each group may communicate with the controller 1200 through one common channel. The controller 1200 may control the plurality of semiconductor memories 100 of the memory device 1100 through the plurality of channels CH1 to CHn.

The controller 1200 is connected between a host 1400 and the memory device 1100. The controller 1200 may access the memory device 1100 in response to a request from the host 1400. For example, the controller 1200 may control a read operation, a write operation, an erase operation, and a background operation of the memory device 1100 in response to a request received from the host 1400. The controller 1200 may provide an interface between the memory device 1100 and the host 1400. The controller 1200 may run firmware for controlling the memory device 1100. Furthermore, the controller 1200 may generate a stream in response to a request of the host 1400 and allocate a super block to the stream. The controller 1200 may allocate free blocks to an initial super block allocated to the stream such that only a minimum number of free blocks (at least one free block) are included in the super block. Further, the controller 1200 may allocate, when all of the free blocks allocated to the super block are consumed, an additional free block to the super block. When a plurality of requests are received from the host 1400, the controller 1200 may generate a plurality of streams corresponding to the respective requests, and allocate super blocks to the respective streams.

The above-mentioned memory system 1000 may be configured to further include a buffer memory.

The host 1400 may control the memory system 1000. The host 1400 may include a portable electronic device, such as a computer, a personal digital assistant (PDA), a portable multimedia player (PMP), an MP3 player, a camera, a camcorder, or a mobile phone. The host 1400 may generate, through a command, a request for a write operation, a read operation, or an erase operation of the memory system 1000.

The controller 1200 and the memory device 1100 may be integrated into a single semiconductor device. In an embodiment, the controller 1200 and the memory device 1100 may be integrated into a single semiconductor device to form a memory card, such as a personal computer memory card international association (PCMCIA), a compact flash card (CF), a smart media card (e.g., SM or SMC), a memory stick multimedia card (e.g., MMC, RS-MMC, or MMCmicro), a secure digital (SD) card (e.g., SD, miniSD, microSD, or SDHC), or a universal flash storage (UFS).

In another embodiment, the controller 1200 and the memory device 1100 may be integrated into a single semiconductor device to form a solid state drive (SSD). The SSD may include a storage device configured to store data in a semiconductor memory. When the memory system 1000 is used as the SSD, the operating speed of the host 1400 coupled to the memory system 1000 may be phenomenally improved.

In an embodiment, the memory system 1000 may be provided as any of various elements of an electronic device such as a computer, a ultra mobile PC (UMPC), a workstation, a net-book, a personal digital assistants (PDA), a portable computer, a web tablet, a wireless phone, a mobile phone, a smart phone, an e-book, a portable multimedia player (PMP), a game console, a navigation device, a black box, a digital camera, a 3-dimensional television, a digital audio recorder, a digital audio player, a digital picture recorder, a digital picture player, a digital video recorder, a digital video player, a device capable of transmitting/receiving information in an wireless environment, one of various devices for forming a home network, any of various electronic devices for forming a computer network, any of various electronic devices for forming a telematics network, an RFID device, or one of various elements for forming a computing system.

In an embodiment, the memory device 1100 or the memory system 1000 may be embedded in various types of packages. For example, the memory device 1100 or the memory system 1000 may be packaged in a type such as Package on Package (PoP), Ball grid arrays (BGAs), Chip scale packages (CSPs), Plastic Leaded Chip Carrier (PLCC), Plastic Dual In Line Package (PDIP), Die in Waffle Pack, Die in Wafer Form, Chip On Board (COB), Ceramic Dual In Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), or Wafer-Level Processed Stack Package (WSP).

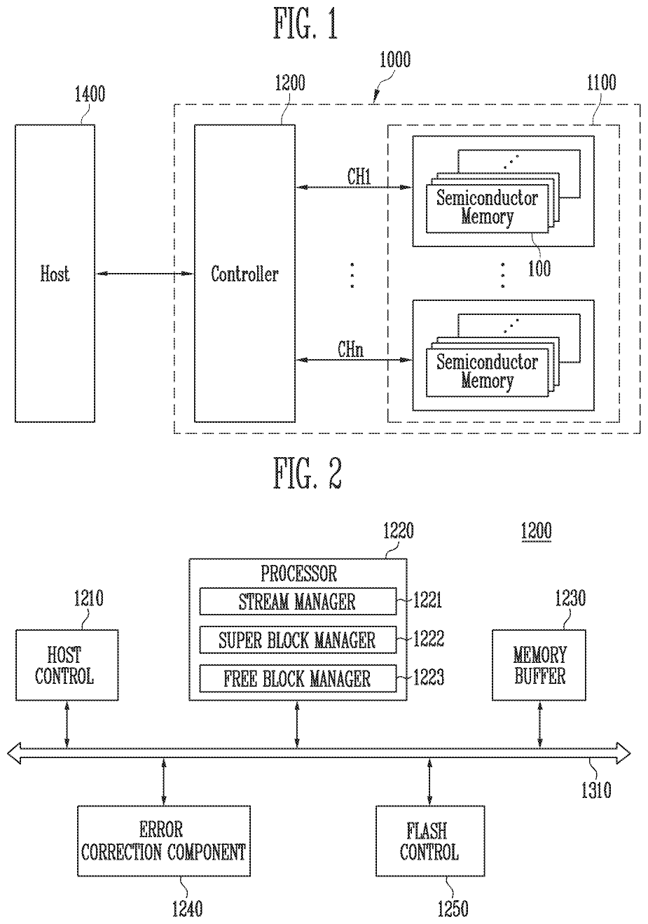

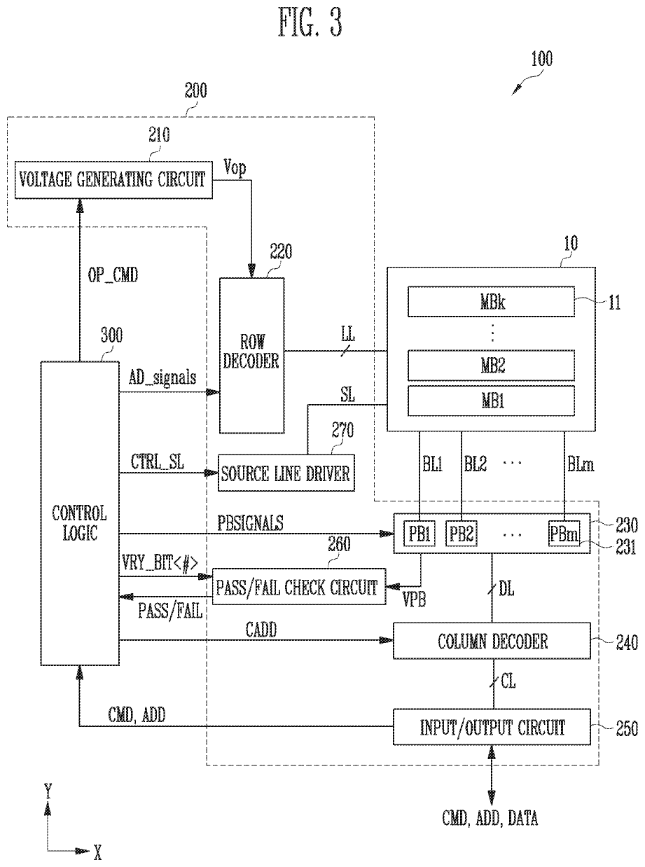

FIG. 2 is a diagram illustrating a controller, e.g., the controller 1200 of FIG. 1, in accordance with an embodiment of the present disclosure.

Referring to FIG. 2, the controller 1200 may include a host control 1210, a processor 1220, a memory buffer 1230, an error correction component 1240, a flash control 1250, and a bus 1310.

The bus 1310 may provide a channel between the components of the controller 1200.

The host control 1210 may control data transmission between a host (e.g., the host 1400 of FIG. 1) and the memory buffer 1230. In an embodiment, the host control 1210 may control an operation of buffering data input from the host 1400 to the memory buffer 1230. In an embodiment, the host control 1210 may control an operation of outputting data buffered in the memory buffer 1230 to the host 1400. The host control 1210 may include a host interface.

The processor 1220 may control the overall operation of the controller 1200 and perform a logical operation. The processor 1220 may communicate with the host 1400 through the host control 1210, and communicate with the memory device 1100 of FIG. 1 through the flash control 1250. Furthermore, the processor 1220 may control the memory buffer 1230. The processor 1220 may control the operation of the memory system 1000 by using the memory buffer 1230 as an operation memory, a cache memory, or a buffer memory.

The processor 1220 may include a stream manager 1221, a super block manager 1222, and a free block manager 1223.

The stream manager 1221 may generate one or more streams during a data write operation, and separately allocate data received from the host 1400 to at least one stream. Each of the streams may correspond to at least one super block of the memory device 1100 of FIG. 1. During a data write operation, the stream manager 1221 may sequentially allocate data successively received from the host 1400 to a selected one of the streams.

The super block manager 1222 may divide some of memory blocks of the plurality of semiconductor memories 100 included in the memory device 1100 into a plurality of super blocks each including at least one memory block, and manage the plurality of super blocks. The super block manager 1222 may configure super blocks such that the super blocks correspond to the streams generated by the stream manager 1221. The super block manager 1222 may configure super blocks such that, when a super block corresponding to a newly generated stream is configured, only a free block is included in the super block. The free block may be an erased block of the plurality of memory blocks included in the memory device 1100. In other words, the free block may be a memory block to which no data is written. For example, the super block manager 1222 may configure super blocks such that, when a super block corresponding to a new stream is configured, only one free block is included in the super block. Furthermore, during a data write operation on a super block corresponding to a stream, in the case where while data for which a write operation has not been completed remain in the stream it is determined that there is no free block capable of performing a write operation because a write operation on a free block included in the super block has been completed and a block close event has occurred, the super block manager 1222 may receive information about a new free block from the free block manager 1223, and adjust the super block configuration such that the new free block is included in the super block. The term “block close” may mean that additional data cannot be stored in a memory block. It may be determined whether to allocate an additional free block to the super block at various times, one of which may be a time at which during the data write operation a write operation on each of data groups corresponding to a transmission unit (e.g., a page) of data that is transmitted from the controller 1200 to the memory device 1100 is completed, and another of which may be a time at which a write operation on all pages included in a memory block on which a write operation is being performed in the super block is completed.

The free block manager 1223 may manage free blocks that are not included in a super block among the plurality of memory blocks included in the memory device 1100 of FIG. 1. In the case where the number of free blocks included in the memory device 1100 is less than a threshold value, the free block manager 1223 may perform an erase operation on a memory block that stores invalid data among the plurality of memory blocks and thus secure an additional free block. Alternatively, the free block manager 1223 may perform a garbage collection operation to secure a free block. The free block manager 1223 may additionally allocate a free block to a super block in response to a request of the super block manager 1222.

The processor 1220 may be implemented as a flash translation layer (FTL). The FTL may drive firmware stored in the memory buffer 1230. During a data write operation, the FTL may map a physical address corresponding to a logical address input from the host 1400 of FIG. 1. Particularly, during the data write operation, the FTL may map the physical address such that data received from the host 1400 is programmed to one of one or more super blocks included in the memory device 1100. During a data read operation, the FTL may check a physical address mapped to a logical address input from the host 1400.

The stream manager 1221, the super block manager 1222, and the free block manager 1223 may be configured to be included in the FTL.

The memory buffer 1230 may be used as an operating memory, a cache memory, or a buffer memory of the processor 1220. The memory buffer 1230 may store codes and commands to be executed by the processor 1220. The memory buffer 1230 may store data to be processed by the processor 1220. The memory buffer 1230 may include a static RAM (SRAM) or a dynamic RAM (DRAM). The memory buffer 1230 may include a command queue generated by the processor 1220.

The error correction component 1240 may perform error correction. The error correction component 1240 may perform an error correction code (ECC) encoding based on data to be written to the memory device 1100 through the flash control 1250. ECC encoded data may be transmitted to the memory device 1100 through the flash control 1250. The error correction component 1240 may perform ECC decoding for data received from the memory device 1100 through the flash control 1250. For example, the error correction component 1240 may be included in the flash control 1250 as a component thereof.

The flash control 1250 may generate and output an internal command for controlling the memory device 1100 in response to commands stored in a command queue generated by the processor 1220. During a data write operation, the flash control 1250 may control an operation of transmitting and programming data buffered in the memory buffer 1230 to the memory device 1100. During a read operation, the flash control 1250 may control an operation of buffering, in the memory buffer 1230, data read and output from the memory device 1100 in response to a command queue. The flash control 1250 may include a flash interface.

FIG. 3 is a diagram illustrating a semiconductor memory, e.g., the semiconductor memory 100 of FIG. 1, in accordance with an embodiment of the present disclosure.

Referring to FIG. 3, the semiconductor memory 100 may include a memory cell array 10 configured to store data. The semiconductor memory 100 may include a peripheral circuit 200 configured to perform a program operation for storing data in the memory cell array 10, a read operation for outputting the stored data, and an erase operation for erasing the stored data. The semiconductor memory 100 may include a control logic 300 configured to control the peripheral circuit 200 under control of a controller (e.g., the controller 1200 of FIG. 1).

The memory cell array 10 may include a plurality of memory blocks MB1 to MBk (11) (where k is a positive integer). Local lines LL and bit lines BL1 to BLm (where m is a positive integer) may be coupled to each of the memory blocks MB1 to MBk (11). For example, the local lines LL may include a first select line, a second select line, and a plurality of word lines arranged between the first and the second select lines. The local lines LL may include dummy lines arranged between the first select line and the word lines and between the second select line and the word lines. Here, the first select line may be a source select line, and the second select line may be a drain select line. For example, the local lines LL may include word lines, drain and source select lines, and source lines SL. The local lines LL may further include dummy lines. The local lines LL may further include pipelines. The local lines LL may be coupled to each of the memory blocks MB1 to MBk (11). The bit lines BL1 to BLm may be coupled in common to the memory blocks MB1 to MBk (11). The memory blocks MB1 to MBk (11) may be embodied in a two- or three-dimensional structure. In the memory blocks 11 having a two-dimensional structure, the memory cells may be arranged in a direction parallel to a substrate. In the memory blocks 11 having a three-dimensional structure, the memory cells may be stacked in a direction perpendicular to the substrate.

The peripheral circuit 200 may perform a program operation, a read operation, or an erase operation on a selected memory block 11 under control of the control logic 300. For instance, the peripheral circuit 200 may include a voltage generating circuit 210, a row decoder 220, a page buffer group 230, a column decoder 240, an input and output (input/output) circuit 250, a pass and fail (pass/fail) check circuit 260, and a source line driver 270.

The voltage generating circuit 210 may generate various operating voltages Vop to be used for a program operation, a read operation, and an erase operation in response to an operating signal OP_CMD. Furthermore, the voltage generating circuit 210 may selectively discharge the local lines LL in response to an operating signal OP_CMD. For example, the voltage generating circuit 210 may generate a program voltage, a verify voltage, a pass voltage, and a select transistor operating voltage under control of the control logic 300. Furthermore, the voltage generating circuit 210 may generate first and second read voltages to monitor threshold voltages of the select transistors. In an embodiment, the second read voltage is greater than the first read voltage.

The row decoder 220 may transmit operating voltages Vop to local lines WL coupled to a selected memory block 11 in response to row decoder control signals AD_signals. For example, the row decoder 220 may selectively apply operating voltages (e.g., a program voltage, a verify voltage, and a pass voltage) generated by the voltage generating circuit 210 to the word lines among the local lines LL in response to the row decoder control signals AD_signals.

During a program voltage applying operation, in response to the row decoder control signals AD_signals, the row decoder 220 may apply a program voltage generated by the voltage generating circuit 210 to a selected word line of the local lines LL, and apply a pass voltage generated by the voltage generating circuit 210 to the other unselected word lines. During a read operation, in response to the row decoder control signals AD_signals, the row decoder 220 may apply a read voltage generated by the voltage generating circuit 210 to a selected word line of the local lines LL, and apply a pass voltage generated by the voltage generating circuit 210 to the other unselected word lines.

The page buffer group 230 may include a plurality of page buffers PB1 to PBm (231) coupled to the bit lines BL1 to BLm. The page buffers PB1 to PBm (231) may operate in response to page buffer control signals PBSIGNALS. For instance, the page buffers PB1 to PBm (231) may temporarily store data to be programmed during a program operation, or sense voltages or currents of the bit lines BL1 to BLm during a read or verify operation.

The column decoder 240 may transmit data between the input/output circuit 250 and the page buffer group 230 in response to a column address CADD. For example, the column decoder 240 may exchange data with the page buffers 231 through data lines DL or exchange data with the input/output circuit 250 through column lines CL.

The input/output circuit 250 may transmit an internal command CMD or an address ADD received from a controller (e.g., the controller 1200 of FIG. 1) to the control logic 300, or exchange data with the column decoder 240.

During a read operation or a verify operation, the pass/fail check circuit 260 may generate a reference current in response to an enable bit VRY_BIT<#>, and may compare a sensing voltage VPB received from the page buffer group 230 with a reference voltage generated by the reference current and output a pass signal PASS or a fail signal FAIL.

The source line driver 270 may be coupled, through the source line SL, to the memory cells included in the memory cell array 10, and may control a voltage to be applied to the source line SL. The source line driver 270 may receive a source line control signal CTRL_SL from the control logic 300, and control a source line voltage to be applied to the source line SL based on the source line control signal CTRL_SL.

The control logic 300 may output an operating signal OP_CMD, a row decoder control signal AD_signals, page buffer control signals PBSIGNALS, and an enable bit VRY_BIT<#> in response to an internal command CMD and an address ADD, and thus control the peripheral circuit 200. In addition, the control logic 300 may determine whether a target memory cell has passed a verification during a verify operation in response to a pass signal PASS or a fail signal FAIL.

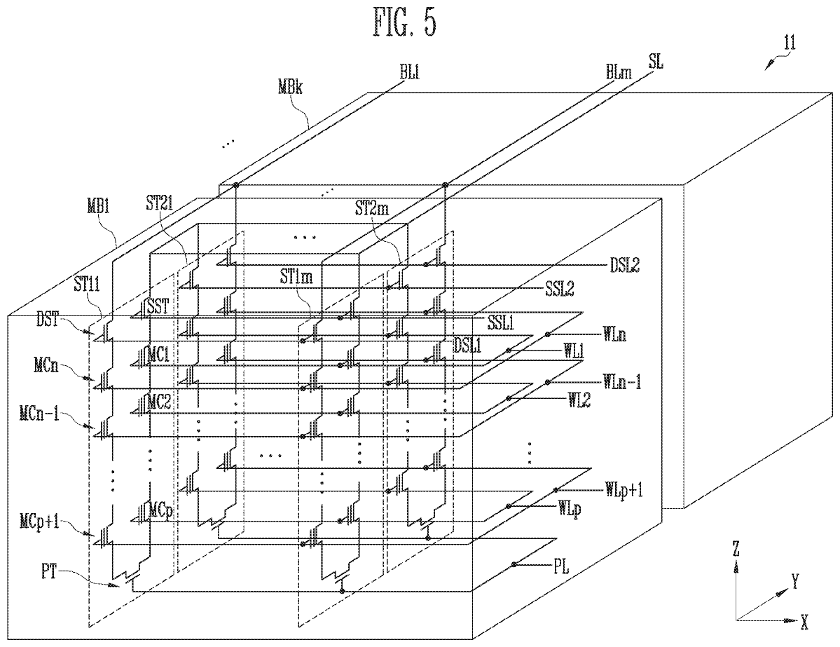

FIG. 4 is a diagram illustrating a memory block 11 of FIG. 3 in accordance with an embodiment of the present disclosure.

Referring to FIG. 4, in the memory block 11, a plurality of word lines arranged parallel to each other may be coupled between a first select line and a second select line. Here, the first select line may be a source select line SSL, and the second select line may be a drain select line DSL. In more detail, the memory block 11 may include a plurality of strings ST coupled between the bit lines BL1 to BLm and the source line SL. The bit lines BL1 to BLm may be respectively coupled to the strings ST, and the source lines SL may be coupled in common to the strings ST. The strings ST may have the same configuration; therefore, the string ST that is coupled to the first bit line BL1 will be described in detail by way of example.

The string ST may include a source select transistor SST, a plurality of memory cells F1 to F16, and a drain select transistor DST which are coupled in series to each other between the source line SL and the first bit line BL1. At least one source select transistor SST and at least one drain select transistor DST may be included in each string ST, and more than the 16 memory cells F1 to F16 shown in the drawing may be included in each string ST.

A source of the source select transistor SST may be coupled to the source line SL, and a drain of the drain select transistor DST may be coupled to the first bit line BL1. The memory cells F1 to F16 may be coupled in series between the source select transistor SST and the drain select transistor DST. Gates of the source select transistors SST included in different strings ST may be coupled to the source select line SSL. Gates of the drain select transistors DST may be coupled to the drain select line DSL. Gates of the memory cells F1 to F16 may be coupled to the plurality of word lines WL1 to WL16. Among the memory cells included in different strings ST, a group of memory cells coupled to each word line may be referred to as a physical page PPG. Therefore, the number of physical pages PPG included in the memory block 11 may correspond to the number of word lines WL1 to WL16.

Each memory cell may store 1-bit data. This memory cell is typically called a single level cell (SLC). In this case, each physical page PPG may store data of a singe logical page LPG. Data of each logical page LPG may include data bits corresponding to the number of cells included in a single physical page PPG. Each memory cell may store 2- or more-bit data. This memory cell is typically called a multi-level cell (MLC). In this case, each physical page PPG may store data of two or more logical pages LPG.

FIG. 5 is a diagram illustrating a memory block having a three-dimensional structure in accordance with an embodiment of the present disclosure.

Referring to FIG. 5, the memory cell array 10 may include a plurality of memory blocks MB1 to MBk (11). Each memory block 11 may include a plurality of strings ST11 to ST1m and ST21 to ST2m. In an embodiment, each of the strings ST11 to ST1m and ST21 to ST2m may be formed in a ‘U’ shape. In the first memory block MB1, m strings may be arranged in a row direction (i.e. an X direction). Although FIG. 5 illustrates that two strings are arranged in a column direction (i.e., a Y direction), three or more strings may be arranged in the column direction (i.e., the Y direction).

Each of the plurality of strings ST11 to ST1m and ST21 to ST2m may include at least one source select transistor SST, first to n-th memory cells MC1 to MCn, a pipe transistor PT, and at least one drain select transistor DST.

The source select transistor SST, the drain select transistor DST, and the memory cells MC1 to MCn may have structures similar to each other. For example, each of the source select transistor SST, the drain select transistor DST, and the memory cells MC1 to MCn may include a channel layer, a tunnel insulating layer, a charge trap layer, and a blocking insulating layer. For example, a pillar for providing the channel layer may be provided in each string. For another example, a pillar for providing at least one of the channel layer, the tunnel insulating layer, the charge trap layer, and the blocking insulating layer may be provided in each string.

The source select transistor SST of each string may be coupled between the source line SL and the memory cells MC1 to MCn.

In an embodiment, source select transistors of strings arranged in the same row may be coupled to a source select line extending in the row direction. Source select transistors of strings arranged in different rows may be coupled to different source select lines. In FIG. 5, source select transistors of the strings ST11 to ST1m in a first row may be coupled to a first source select line SSL1. Source select transistors of the strings ST21 to ST2m in a second row may be coupled to a second source select line SSL2.

In an embodiment, the source select transistors of the strings ST11 to ST1m and ST21 to ST2m may be coupled in common to a single source select line.

The first to n-th memory cells MC1 to MCn in each string may be coupled between the source select transistor SST and the drain select transistor DST.

The first to n-th memory cells MC1 to MCn may be divided into first to p-th memory cells MC1 to MCp and (p+1)-th to n-th memory cells MCp+1 to MCn. The first to p-th memory cells MC1 to MCp may be successively arranged in a vertical direction (i.e., in a Z direction) and coupled in series to each other between the source select transistor SST and the pipe transistor PT. The (p+1)-th to n-th memory cells MCCp+1 to MCn may be successively arranged in the vertical direction (i.e., the Z direction) and coupled in series to each other between the pipe transistor PT and the drain select transistor DST. The first to p-th memory cells MC1 to MCp and the (p+1)-th to n-th memory cells MCp+1 to MCn may be coupled to each other through the pipe transistor PT. Gates of the first to n-th memory cells MC1 to MCn of each string may be respectively coupled to first to n-th word lines WL1 to WLn.

In an embodiment, at least one of the first to n-th memory cells MC1 to MCn may be used as a dummy memory cell. In the case where the dummy memory cell is provided, the voltage or the current of the corresponding string may be stably controlled. Gates of the pipe transistors PT of the respective strings may be coupled to a pipeline PL.

The drain select transistor DST of each string may be coupled between the corresponding bit line and the memory cells MCp+1 to MCn. Strings arranged in the row direction may be coupled to corresponding drain select lines extending in the row direction. The drain select transistors of the strings ST11 to ST1m in the first row may be coupled to a first drain select line DSL1. The drain select transistors of the strings ST21 to ST2m in the second row may be coupled to a second drain select line DSL2.

Strings arranged in the column direction may be coupled to corresponding bit lines extending in the column direction. In FIG. 5, the strings ST11 and ST21 in a first column may be coupled to a first bit line BL1. The strings ST1m and ST2m in an m-th column may be coupled to an m-th bit line BLm.

Among the strings arranged in the row direction, memory cells coupled to the same word line may form one page. For example, memory cells coupled to the first word line WL1 in the strings ST11 to ST1m of the first row may form a single page. Memory cells coupled to the first word line WL1 in the strings ST21 to ST2m of the second row may form another single page. When any one of the drain select lines DSL1 and DSL2 is selected, strings arranged in the corresponding row may be selected. When any one of the word lines WL1 to WLn is selected, a corresponding single page may be selected from the selected strings.

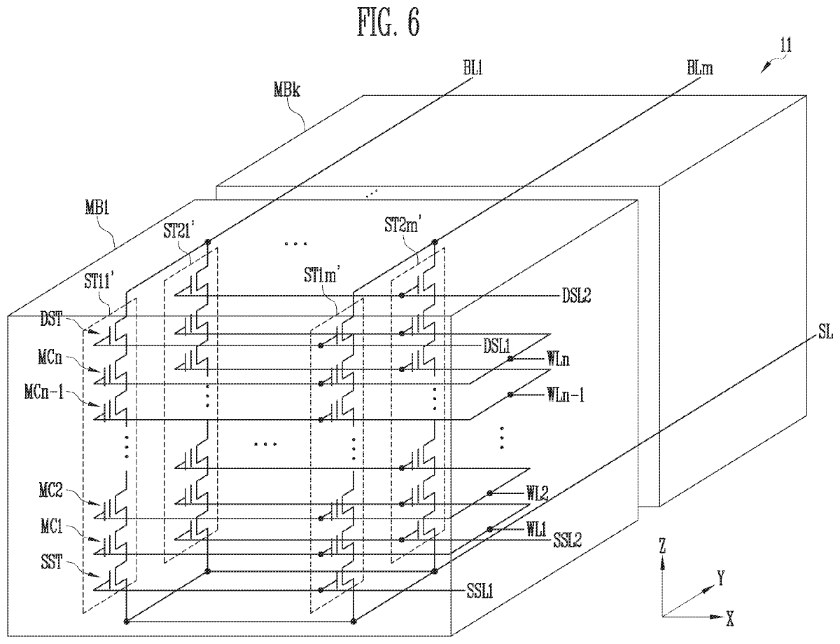

Referring to FIG. 6, the memory cell array 10 may include a plurality of memory blocks MB1 to MBk (11). Each memory block 11 may include a plurality of strings ST11′ to ST1m′ and ST21′ to ST2m′. Each of the strings ST11′ to ST1m′ and ST21′ to ST2m′ may extend in a vertical direction (i.e., in a Z direction). In each memory block 11, m strings may be arranged in a row direction (i.e., in an X direction). Although FIG. 6 illustrates that two strings are arranged in a column direction (i.e., in a Y direction), three or more strings may be arranged in the column direction (i.e., the Y direction).

Each of the strings ST11′ to ST1m′ and ST21′ to ST2m′ may include at least one source select transistor SST, first to n-th memory cells MC1 to MCn, and at least one drain select transistor DST.

The source select transistor SST of each string may be coupled between the source line SL and the memory cells MC1 to MCn. Source select transistors of strings arranged in the same row may be coupled to the same source select line. The source select transistors of the strings ST11′ to ST1m′ arranged in a first row may be coupled to a first source select line SSL1. The source select transistors of the strings ST21′ to ST2m′ arranged in a second row may be coupled to a second source select line SSL2. In an embodiment, the source select transistors of the strings ST11′ to ST1m′ and ST21′ to ST2m′ may be coupled in common to a single source select line.

The first to n-th memory cells MC1 to MCn in each string may be coupled in series between the source select transistor SST and the drain select transistor DST. Gates of the first to n-th memory cells MC1 to MCn may be respectively coupled to first to n-th word lines WL1 to WLn.

In an embodiment, at least one of the first to n-th memory cells MC1 to MCn may be used as a dummy memory cell. In the case where the dummy memory cell is provided, the voltage or the current of the corresponding string may be stably controlled. Thereby, the reliability of data stored in each memory block 11 may be improved.

The drain select transistor DST of each string may be coupled between the corresponding bit line and the memory cells MC1 to MCn. Drain select transistors DST of strings arranged in the row direction may be coupled to corresponding drain select lines extending in the row direction. The drain select transistors DST of the strings ST11′ to ST1m′ in the first row may be coupled to a first drain select line DSL1. The drain select transistors DST of the strings ST21′ to ST2m′ in the second row may be coupled to a second drain select line DSL2.

FIG. 7 is a diagram illustrating a configuration of a super block in accordance with an embodiment of the present disclosure.

Referring to FIG. 7, each of a plurality of semiconductor memories 100_1 to 100_x may include a plurality of memory blocks MB1 to MBk. Each of a plurality of super blocks SB1 to SB3 may include at least one of the plurality of memory blocks MB1 to MBk. For example, the first super block SB1 may include the first memory block MB1 of the first semiconductor memory 100_1 and the first memory block MB1 of the second semiconductor memory 100_2. The second super block SB2 may include the second memory block MB2 of the first semiconductor memory 100_1.

In the case where a multi-plane operation is possible in each semiconductor memory, at least two memory blocks included in one semiconductor memory may be included to one super block in the same manner as that of the third super block SB3. For example, the third super block SB3 may include the third memory block MB3 of the first semiconductor memory 100_1, the second and the third memory blocks MB2 and MB3 of the second semiconductor memory 100_2, and the first memory block MB1 of the x-th semiconductor memory 100_x.

When a new super block is configured, free blocks of memory blocks that are not included in super blocks may be included in the new super block. When an existing super block needs an additional free block, at least one of the free blocks may be added and allocated to the super block.

FIG. 8 is a diagram illustrating a multi-stream operation between a controller and a memory device, e.g., the controller 1200 and the memory device 1100 of FIG. 1, in accordance with an embodiment of the present disclosure.

Referring to FIG. 8, the controller 1200 may map a plurality of streams stream_1 to stream_y to a plurality of super blocks SB1 to SBy included in the memory device 1100, respectively. The controller 1200 may perform a data write operation or a data read operation based on the mapping results. Data write operations or data read operations of the respective streams stream_1 to stream_y may be performed in parallel with each other when operating times thereof overlap each other.

In the case where the controller 1200 generates a new stream and maps it to a new super block, the new stream may be mapped to a super block to which a stream has not been mapped among the existing super blocks, or the new super block may be newly configured.

In an embodiment of the present disclosure, it is illustrated that each of the streams stream_1 to stream_y corresponds to one super block, but the present disclosure is not limited thereto. For example, one stream may correspond to a plurality of super blocks.

FIG. 9 is a flowchart illustrating an operation of a memory system in accordance with an embodiment of the present disclosure.

The operation of FIG. 9 will be described with additional references to FIGS. 1 to 8.

The case where a write request is received from the host 1400 of FIG. 1 and a data write operation is performed is described by way of example. In an embodiment, data write operations on super blocks respectively corresponding to a plurality of streams may overlap with each other and be simultaneously performed.

If a write request, data, and a logical address are received from the host 1400 (at step S910), the processor 1220 of the controller 1200 may generate a write command in response to the write request and store the write command in a command queue (at step S920). Further, the processor 1220 generates streams stream_1 to stream_y (at step S920).

The super block manager 1222 of the processor 1220 may configure a plurality of super blocks SB1 to SBy respectively corresponding to the streams stream_1 to stream_y and allocate the super blocks SB1 to SBy to the respective streams stream_1 to stream_y (at step S930). Here, each of the super blocks SB1 to SBy may be configured to include a minimum number of free blocks based on the amount of write data corresponding to the associated stream (stream_1 to stream_y). That is, the minimum number of free blocks allocated to a given super block is based on the amount of data in the stream associated with that super block.

The flash control 1250 of the controller 1200 may generate and output an internal command (e.g., write command) for controlling the memory device 1100 in response to commands stored in the command queue generated by the processor 1220.

The semiconductor memory 100 may include a selected free block among the free blocks in the super blocks of the memory device 1100. The semiconductor memory 100 may perform a data write operation for data received from the controller 1200 in response to an internal command CMD and an address ADD that are received from the controller 1200 (at step S940). When the controller 1200 transmits the data to the memory device 1100, the entire data may be divided into a plurality of data groups, each being a data transmission unit, and the data groups may be sequentially transmitted to the memory device 1100.

During the data write operation, when a write operation for each data group is completed, the super block manager 1222 of the controller 1200 may determine whether an additional free block is needed for the super block (at step S950). For example, during a data write operation on the first super block SB1 corresponding to the first stream stream_1, if a programmable free block exists in the first super block SB1 while a data group that has not yet been transmitted remains when a data write operation for each of the plurality of data groups is completed, the super block manager 1222 may determine that an additional free block is not needed (S950, NO). If a programmable free block does not exist in the first super block SB1, the super block manager 1222 may determine that an additional free block is needed (S950, YES). Furthermore, when a data write operation for the last data group is completed, the super block manager 1222 may determine that an additional free block is not needed (S950, NO).

In the case where all pages included in a memory block (e.g., MB1) on which a data write operation is currently performed among the memory blocks included in the first super block SB1 have been programmed, if a data group that has not yet transmitted exists, it is determined that an additional free block is needed (S950, YES). On the other hand, if all of the data groups have been transmitted and the data write operation has been completed, it is determined that an additional free block is not needed (S950, NO).

As a result of the determination step S950, if it is determined that an additional free block is needed for the super block (S950, YES), the super block manager 1222 may allocate at least one new additional free block to the first super block SB1, thus adjusting the configuration of the first super block SB1. In an embodiment, the new additional free block allocated to the first super block SB1 may be at least one of free blocks that are not included in the existing super blocks SB1 to SBy among the plurality of memory blocks in the memory device 1100 and managed by the free block manager 1223.

Although in the above description of steps S940 to S960 the data write operation and the additional free block allocating method pertaining to the first super block SB1 corresponding to stream_1 have been described by way of example, the data write operation and the additional free block allocating operation may also be applied in the same manner to any of the second to y-th super blocks SB2 to SBy corresponding to the other streams stream_2 to stream_y.

As described above, in the memory system 1000 that supports multi-streams, during a data write operation, after only a minimum number of free blocks are allocated to a super block corresponding to the stream associated with that super block, an additional free block may be allocated to the super block depending on whether data to be written remains. Thus, the number of free blocks of the memory device 1100 that are used to configure a plurality of super blocks may be minimized. Consequently, the number of configurable super blocks may be increased. Furthermore, the number of streams that may be generated by the controller 1200 may be increased by increasing the number of super blocks.

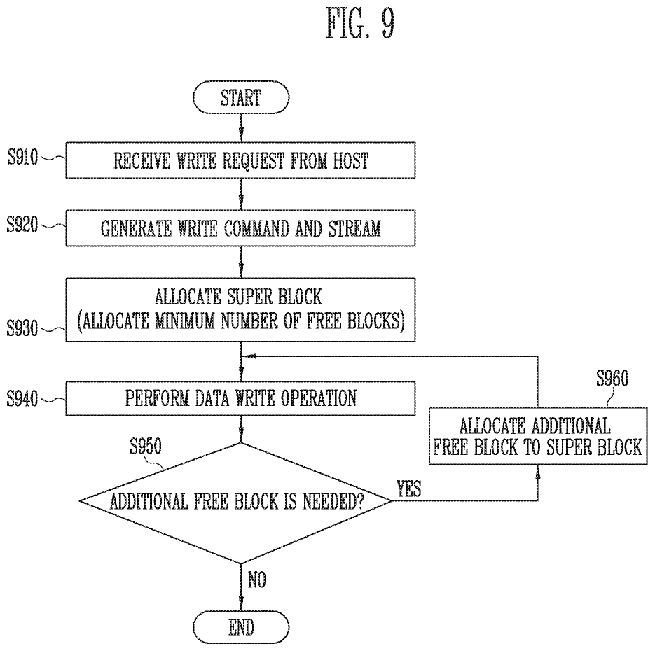

FIG. 10 is a diagram illustrating a memory system 30000 in accordance with an embodiment of the present disclosure.

Referring to FIG. 10, the memory system 30000 may be embodied in a cellular phone, a smartphone, a tablet personal computer (PC), a personal digital assistant (PDA) or a wireless communication device. The memory system 30000 may include a memory device 1100, and a controller 1200 capable of controlling the operation of the memory device 1100. The controller 1200 may control a data access operation, e.g., a program operation, an erase operation, or a read operation, of the memory device 1100 under control of a processor 3100.

Data programmed to the memory device 1100 may be output through a display 3200 under control of the controller 1200.

The memory device 1100 may be formed of one or more super blocks, as illustrated in FIGS. 7 and 8, and may be operated in a multi-stream manner with the controller 1200.

A radio transceiver 3300 may send and receive radio signals through an antenna ANT. For example, the radio transceiver 3300 may convert a radio signal received through the antenna ANT into a signal capable of being processed in the processor 3100. Therefore, the processor 3100 may process a signal output from the radio transceiver 3300 and transmit the processed signal to the controller 1200 or the display 3200. The controller 1200 may program a signal processed by the processor 3100 to the memory device 1100. Furthermore, the radio transceiver 3300 may convert a signal output from the processor 3100 into a radio signal, and output the changed radio signal to an external device through the antenna ANT. An input device 3400 may be used to input a control signal for controlling the operation of the processor 3100 or data to be processed by the processor 3100. The input device 3400 may be embodied in a pointing device such as a touch pad and a computer mouse, a keypad or a keyboard. The processor 3100 may control the operation of the display 3200 such that data output from the memory controller 1200, data output from the radio transceiver 3300, or data output form the input device 3400 is output through the display 3200.

In an embodiment, the controller 1200 capable of controlling the operation of the memory device 1100 may be embodied as a part of the processor 3100 or a chip provided separately from the processor 3100. Alternatively, the controller 1200 may be embodied by an example of the controller shown in FIG. 2.

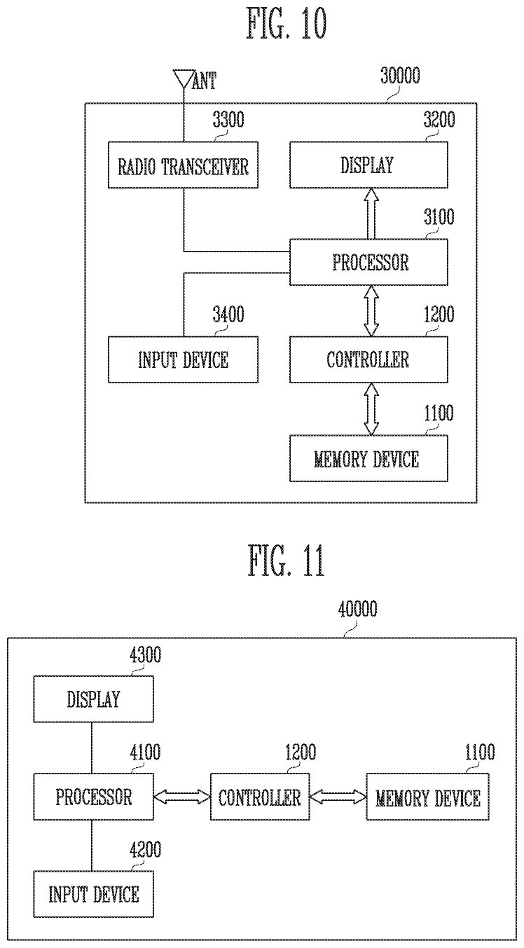

FIG. 11 is a diagram illustrating a memory system 40000 in accordance with an embodiment of the present disclosure.

Referring to FIG. 11, the memory system 40000 may be embodied in a personal computer (PC), a tablet PC, a net-book, an e-reader, a personal digital assistant (PDA), a portable multimedia player (PMP), an MP3 player, or an MP4 player.

The memory system 40000 may include a memory device 1100, and a controller 1200 capable of controlling a data processing operation of the memory device 1100.

The memory device 1100 may be formed of one or more super blocks, as illustrated in FIGS. 7 and 8, and may be operated in a multi-stream manner with the controller 1200.

A processor 4100 may output data stored in the memory device 1100 through a display 4300, according to data input from an input device 4200. For example, the input device 4200 may be embodied in a pointing device such as a touch pad or a computer mouse, a keypad, or a keyboard.

The processor 4100 may control the overall operation of the memory system 40000 and control the operation of the controller 1200. In an embodiment, the controller 1200 capable of controlling the operation of the memory device 1100 may be embodied as a part of the processor 4100 or a chip provided separately from the processor 4100. Alternatively, the controller 1200 may be embodied by an example of the controller shown in FIG. 2.

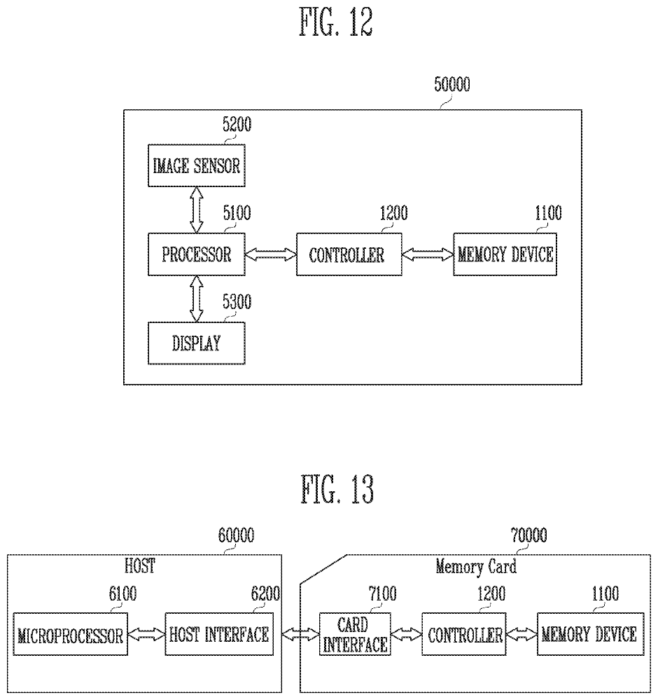

FIG. 12 is a diagram illustrating a memory system 50000 in accordance with an embodiment of the present disclosure.

Referring to FIG. 12, the memory system 50000 may be embodied in an image processing device, e.g., a digital camera, a portable phone provided with a digital camera, a smartphone provided with a digital camera, or a tablet PC provided with a digital camera.

The memory system 50000 may include a memory device 1100, and a controller 1200 capable of controlling a data processing operation, e.g., a program operation, an erase operation, or a read operation, of the memory device 1100.

An image sensor 5200 of the memory system 50000 may convert an optical image into digital signals. The converted digital signals may be transmitted to a processor 5100 or the controller 1200. Under control of the processor 5100, the converted digital signals may be output through a display 5300 or stored to the memory device 1100 through the controller 1200. Data stored in the memory device 1100 may be output through the display 5300 under control of the processor 5100 or the controller 1200.

The memory device 1100 may be formed of one or more super blocks, as illustrated in FIGS. 7 and 8, and may be operated in a multi-stream manner with the controller 1200.

In an embodiment, the controller 1200 capable of controlling the operation of the memory device 1100 may be embodied as a part of the processor 5100 or a chip provided separately from the processor 5100. Alternatively, the controller 1200 may be embodied by an example of the controller shown in FIG. 2.

FIG. 13 is a diagram illustrating a memory system 70000 in accordance with an embodiment of the present disclosure.

Referring to FIG. 13, the memory system 70000 may be embodied in a memory card or a smart card. The memory system 70000 may include a memory device 1100, a controller 1200, and a card interface 7100.

The memory device 1100 may be formed of one or more super blocks, as illustrated in FIGS. 7 and 8, and may be operated in a multi-stream manner with the controller 1200.

The memory controller 1200 may control data exchange between the memory device 1100 and the card interface 7100. In an embodiment, the card interface 7100 may be a secure digital (SD) card interface or a multi-media card (MMC) interface, but it is not limited thereto. The controller 1200 may be embodied by an example of the controller 1200 shown in FIG. 2.

The card interface 7100 may interface data exchange between a host 60000 and the controller 1200 according to a protocol of the host 60000. In an embodiment, the card interface 7100 may support a universal serial bus (USB) protocol, and an interchip (IC)-USB protocol. Here, the card interface may refer to hardware capable of supporting a protocol which is used by the host 60000, software installed in the hardware, or a signal transmission scheme.

When the memory system 70000 is connected to a host interface 6200 of the host 60000 such as a personal computer (PC), a tablet PC, a digital camera, a digital audio player, a cellular phone, console video game hardware or a digital set-top box, the host interface 6200 may perform data communication with the memory device 1100 through the card interface 7100 and the controller 1200 under control of a microprocessor 6100.

In accordance with embodiments of the present disclosure, in a memory system capable of a multi-stream operation, a super block including a minimum number of free blocks may be allocated to each stream, and an additional free block may be allocated to a super block corresponding to a stream that lacks a free block, whereby a plurality of stream operations may be maintained.

Although various embodiments of the present disclosure have been disclosed, those skilled in the art will appreciate that various modifications, additions and substitutions are possible, without departing from the scope and spirit of the present disclosure.

Therefore, the scope of the present disclosure is defined by the appended claims and equivalents of the claims rather than by the description preceding them.

In the above-discussed embodiments, steps may be selectively performed or skipped. In addition, the steps in each embodiment may not be always performed in regular order. Furthermore, the embodiments disclosed in the present specification and the drawings aims to help those skilled in this art more clearly understand the present disclosure rather than aiming to limit the bounds of the present invention. In other words, one skilled in the art to which the present disclosure belongs will be able to easily understand that various modifications are possible based on the technical scope of the present disclosure.

Embodiments of the present disclosure have been described with reference to the accompanying drawings, and specific terms or words used in the description should be construed in accordance with the spirit of the present disclosure without limiting the subject matter thereof. It should be understood that many variations and modifications of the basic inventive concept described herein will still fall within the spirit and scope of the present disclosure as defined in the appended claims and their equivalents.

What is claimed is:

1. A memory system comprising:
a memory device including a plurality of memory blocks; and
a controller configured to generate one or more streams in response to a request from a host, configure one or more super blocks respectively corresponding to the one or more streams, each of the one or more super blocks including free blocks, and control the memory device to perform a data write operation on the one or more super blocks,
wherein the controller allocates, among the one or more super blocks, an additional free block to a super block that needs the additional free block when the data write operation has not yet been completed.

2. The memory system according to claim 1, wherein the controller configures the one or more super blocks such that one or more free blocks of the plurality of memory blocks are included in each of the one or more super blocks.

3. The memory system according to claim 1, wherein the controller configures the one or more super blocks such that a minimum number of free blocks of the plurality of memory blocks are included in each of the one or more super blocks.

4. The memory system according to claim 1, wherein the memory device sequentially performs program operations for respective data groups that are sequentially received from the controller during the data write operation.

5. The memory system according to claim 4, wherein, when a data group that has not been transmitted from the controller to the memory device remains when the program operation for each of the data groups is completed, the controller allocates the additional free block to the corresponding super block.

6. The memory system according to claim 4, wherein the controller comprises:
a stream manager configured to generate, when a request is received from the host, the one or more streams in response to the request;
a super block manager configured to configure the one or more super blocks respectively corresponding to the one or more streams such that at least one of the free blocks of the plurality of memory blocks is included in each of the one or more super blocks; and
a free block manager configured to manage free blocks that have not been included in the one or more super blocks.

7. The memory system according to claim 6, wherein, when a target super block that needs the additional free block exists among the one or more super blocks when the program operation for each of the plurality of data groups is completed, the super block manager receives information about a new free block from the free block manager and allocates the new free block to the target super block.

8. The memory system according to claim 1, wherein, when all pages of a target memory block on which the data write operation is being performed are completely programmed, the controller determines whether to allocate the additional free block to a super block including the target memory block.

9. A memory system comprising:
a memory device including a plurality of memory blocks; and
a controller configured to allocate some of the plurality of memory blocks to a super block, the allocated memory blocks including programmable free blocks, and control the memory device to perform a data write operation on the super block,
wherein, when all programmable free blocks of the allocated memory blocks are consumed when the data write operation on the super block has not been completed, the controller adds an additional free block, among the plurality of memory blocks excluding the allocated memory blocks, to the super block.

10. The memory system of claim 9, wherein the controller allocates a minimum number of memory blocks to the super block.

11. The memory system according to claim 9, wherein, during the data write operation, the memory device sequentially performs program operations for respective data groups that are sequentially received from the controller.

12. The memory system according to claim 11, wherein, when a data group that has not been transmitted from the controller to the memory device remains when the program operation for each of the data groups is completed, the controller allocates the additional free block to the super block.

13. The memory system according to claim 9, wherein, during the data write operation on the super block, when all pages of a target memory block on which a program operation is being performed are completely programmed, the controller allocates the additional free block to the super block.

14. A method of operating a memory system, comprising:
generating a stream in response to a write request from a host;
configuring a super block including free blocks of a plurality of memory blocks included in a memory device;
allocating the super block to the stream;
performing a data write operation on the super block; and
reconfiguring the super block by adding an additional free block to the super block when all of the free blocks included in the super block are consumed during the data write operation.

15. The method according to claim 14, wherein the configuring of the super block comprises configuring the super block to include a minimum number of free blocks.

16. The method according to claim 14, wherein the performing of the data write operation comprises sequentially performing program operations on the super block for respective data groups that are sequentially received during the data write operation.

17. The method according to claim 16, wherein, when the program operation for each of the data groups is completed, the memory system determines whether to add the additional free block to the super block.

18. The method according to claim 14, wherein, during the data write operation, when all pages of a target memory block on which a program operation is being performed, among memory blocks in the super block, are completely programmed, the memory system determines whether to add the additional free block to the super block.

19. The method according to claim 14, further comprising:
generating a new stream when a new write request is received from the host;
configuring a new super block and allocating the new super block to the new stream; and
performing a data write operation on the new super block.
